(19) United States
(12) Patent Application Publication
(10) Pub. No.: US 2024/0104337 A1
(43) Pub. Date: Mar. 28, 2024

(54) RECONFIGURABLE MULTILAYER IMAGE PROCESSING ARTIFICIAL INTELLIGENCE NETWORK

(71) Applicant: Synaptics Incorporated, San Jose, CA (US)

(72) Inventors: Byas Muni, Bengaluru (IN); Ashish Devre, Bengaluru (IN); Aftab Tamboli, Bengaluru (IN)

(21) Appl. No.: 17/936,321

(22) Filed: Sep. 28, 2022

(51) Int. Cl. G06N 3/04; G06T 3/40

(52) U.S. Cl. CPC G06N 3/04; G06T 3/4046

(57) ABSTRACT

This disclosure provides methods, devices, and systems for an artificial intelligence (AI) network. The present implementations more specifically relate to an AI network on an application specific integrated circuit (ASIC) operable as a reconfigurable multilayer image processor capable of implementing different AI models. In some aspects, each layer in the multilayer AI network includes a plurality of multiplier-accumulator (MAC) units, and at least one layer is partitioned into a plurality of blocks of MAC units that are reconfigurable to operate independently or to operate in one or more combinations of blocks of MAC units. The arrangement of the plurality of blocks of MAC units in the at least one layer enables implementation of one or more virtual layers, reconfiguration of the input depth size, reconfiguration of the output feature map size, or a combination thereof, which may be used to executes a desired AI model for image processing.

### TECHNICAL FIELD

The present implementations relate generally to an artificial intelligence (AI) network, and specifically to an AI network on an application specific integrated circuit (ASIC) operable as a reconfigurable multilayer image processor capable of implementing different AI models.

### BACKGROUND OF RELATED ART

Image processing enables a captured image to be rendered on a display such that the original scene can be accurately reproduced, e.g., given the capabilities or limitations of the image capture device or display device. For example, an image processor may be used for image scaling, e.g., the resizing of a digital image such as the magnification of video images, which is referred to as upscaling or resolution enhancement. Digital images may additionally be down scaled to decrease the magnification of video images. Image processing may be used for other affects, as well, such as to adjust the pixel values for images that are captured under low light conditions to correct for inaccuracies in brightness, color, and noise.

Existing image processing techniques often apply algorithmic filters to increase or decrease the number of pixels to adjust pixel values. Algorithmic filters for image processing, for example, are often developed using machine learning techniques for improving the ability of a computer system or application to perform a certain task. Machine learning can be broken down into two component parts: training and inferencing. During the training phase, a machine learning system may be provided with one or more “answers” and one or more sets of raw data to be mapped to each answer. The machine learning system may perform statistical analysis on the raw data to “learn” or model a set of rules (such as a common set of features) that can be used to describe or reproduce the answer. Deep learning, for example, is a particular form of machine learning in which the model being trained is a multi-layer “neural network.” During the inferencing phase, the machine learning system may apply the rules to new data to generate answers or inferences about the data.

The training phase is generally performed using specialized hardware that operates on floating-point precision input data. By contrast, the inferencing phase is often performed on edge devices with limited hardware resources (such as limited processor bandwidth, memory, or power). For example, to increase the speed and efficiency of inferencing operations, many edge devices implement artificial intelligence (AI) networks (also referred to as AI accelerators or AI processors) that are specifically designed to manage highly parallelized low-precision computations. Such AI networks may include arithmetic logic units (ALUs) that can be configured to operate on operands of limited size. The AI networks for image processing are typically optimized based on the training model, which increases speed and efficiency of the inferencing operations, but may lead to inefficiencies if the training model is updated or improved.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

As described herein, an AI network on an application specific integrated circuit (ASIC) is operable as a reconfigurable multilayer image processor capable of implementing different AI models. In some aspects, each layer in the multilayer AI network includes a plurality of multiplier-accumulator (MAC) units, and at least one layer is partitioned into a plurality of blocks of MAC units that are reconfigurable to operate independently or to operate in one or more combinations of blocks of MAC units. The arrangement of the plurality of blocks of MAC units in the at least one layer enables implementation of one or more virtual layers, reconfiguration of the input depth size, reconfiguration of the output feature map size, or a combination thereof, which may be used to executes a desired AI model for image processing.

One aspect of the subject matter of this disclosure is implemented in an artificial intelligence (AI) network on an application specific integrated circuit (ASIC) operable as a reconfigurable multilayer image processor. The AI network includes multiple layers comprising an input layer that receives an image input, an output layer that produces an image output, and at least one intermediate layer between the input layer and the output layer; each layer comprising a plurality of multiplier-accumulator (MAC) units; and at least one layer is partitioned into a plurality of blocks of MAC units, the plurality of blocks of MAC units being reconfigurable to operate independently or to operate in one or more combinations of blocks of MAC units, wherein reconfiguration of the plurality of blocks of MAC units executes changes in an AI model for the image processing.

One aspect of the subject matter of this disclosure is implemented in a method of reconfiguring an artificial intelligence (AI) network on an application specific integrated circuit (ASIC) operable as a reconfigurable multilayer image processor. The method includes receiving an artificial intelligence (AI) model for image processing, configuring the AI network based on the AI model, wherein the AI network comprises: multiple layers comprising an input layer that receives an image input, an output layer that produces an image output, and at least one intermediate layer between the input layer and the output layer, each layer comprising a plurality of multiplier-accumulator (MAC) units; and at least one layer being partitioned into a plurality of blocks of MAC units, the plurality of blocks of MAC units being reconfigurable to operate independently or to operate in one or more combinations of blocks of MAC units. The method further includes receiving changes in the AI model for the image processing; and reconfiguring the plurality of blocks of MAC units to execute the changes in the AI model for the image processing.

### BRIEF DESCRIPTION OF THE DRAWINGS

The present implementations are illustrated by way of example and are not intended to be limited by the figures of the accompanying drawings.

FIG. 1 shows a block diagram of an example image receiver and display system, according to some implementations.

FIG. 2 shows a block diagram of an example four (4) layer AI network configured for image processing.

FIG. 3 shows a block diagram of an example of a reconfigurable AI network configured for image processing.

FIG. 4 shows an illustrative flowchart depicting an example process to implement a reconfigurable multilayer image processing AI network.

FIG. 5 shows a block diagram of an example of a reconfigurable AI network configured for image processing, illustrating a top-level partition of processing blocks to support the reconfigurable network.

FIG. 6 shows a table that illustrates various arrangements and the resulting configurations that may be supported by blocks A, B, C, D in layer2 of the reconfigurable AI network shown in FIG. 5.

FIG. 7 shows a table that illustrates various arrangements and the resulting configurations that may be supported by blocks E, F, G, H in layer3 of the reconfigurable AI network shown in FIG. 5.

FIG. 8, which is partitioned into FIGS. 8A and 8B, illustrates an example of a control path for an AI network to support a plurality of configurations of the partitioned processing blocks for the reconfigurable network.

FIGS. 9 and 10, by way of example, show tables that illustrate various arrangements for a 5-layer configuration and a 6-layer configuration, respectively, that may be supported by the AI network shown in FIG. 8.

FIG. 11 shows an illustrative flowchart depicting an example operation of reconfiguring an artificial intelligence (AI) network on an application specific integrated circuit (ASIC) operable as a reconfigurable multilayer image processor, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits, and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine, any of which being capable of executing scripts or instructions of one or more software programs stored in memory that when executed cause it to perform one or more functions as described herein and to operate as a special-purpose processor.

As described herein, image processing generally enables a captured image (which includes video images) to be rendered on a display such that the original scene can be accurately reproduced. An image processor may be used for image scaling, e.g., upscaling, downscaling, or other affects, such as adjustment of pixel values to improve image quality. Algorithmic filters for image processing are often developed using machine learning techniques for training and inferencing. With a training model is developed, e.g., based on a training set of images, an AI network may be produced that is specifically designed to manage highly parallelized low-precision computations and optimized based on the training model.

An AI networks, for example, may include arithmetic logic units (ALUs) that can be configured to operate on operands of limited size. For image processing, AI networks may include multiple multiplication and addition operations in a feed forward network. The multiplication and addition operations may be performed by hardware circuits known as multiplier-accumulator (MAC) units, and the operation itself is also often referred to as a MAC operation or equivalently a multiply-add (MAD) operation. The MAC operation is a common step that computes the product of two numbers and adds that product to an accumulator, e.g., a←a+(b×c). Often, for image processing, the AI model implemented by the AI network is optimized by tuning number of feature maps and number of layers based on training on a wide set of images.

Continuous development in the algorithm domain and training of the AI network may produce a better fine-tuned AI model to solve a problem at a later stage of time during experiment or exploration. For example, an improved set of training images may become available resulting in an improved model. It is desirable to update the image processing AI network based on the improved training model.

For a Graphics Processing Unit (GPU) or Central Processing Unit (CPU), which are instruction based processors, once an improved training model has been developed, reconfiguration of the GPU/CPU based AI network is relatively easy as the processing instructions may be updated. Instruction execution parallelization may be performed over multiple execution units and multiple real/virtual threads.

When the image processing AI network, however, is implemented using hardware units, for example, with an Application Specific Integrated Circuit (ASIC), flexibilities supported by CPU/GPU implementations are not possible. Nevertheless, it is desirable to provide enough programmability in an imaging processing AI network implemented in hardware that it can be used and reused for different configurations of an AI network. By implementing flexibility in the ASIC for image processing, the image processing AI network may be configurable enough to accommodate a better fine-tuned model without requiring a redesign of the ASIC. Moreover, it is desirable that flexibility in the ASIC is implemented with little hardware cost and complexity. For example, any implemented AI network hardware should be configurable enough to accommodate the AI model changes without burdening implementation with control paths and configurability related logics. Typically, reconfigurability of an AI network is not required at a granular level to accommodate a better tuned model. An approach to implement flexible hardware that provides configurability at a basic execution unit level may result in most of the control paths not being used, which increases the burden in terms of hardware cost.

Various aspects as described herein relate to reconfigurability of AI network hardware on an application specific integrated circuit (ASIC) operable as a reconfigurable multilayer image processor. For example, each layer of the reconfigurable multilayer image processor may include a plurality of multiplier-accumulator (MAC) units configured to execute an AI model for image processing. At least one layer is partitioned into a plurality of blocks of MAC units that are reconfigurable to operate independently or to operate in one or more combinations of blocks of MAC units. The reconfiguration of the plurality of blocks of MAC units executes changes in the AI model for the image processing. In some implementations, the reconfigurability of the plurality of blocks of MAC units enables implementation of one or more virtual layers in addition to the multiple layers, which may be used to execute changes in the AI model. In some implementations, the reconfigurability of the plurality of blocks of MAC units enables reconfiguration of an input depth size, output feature map size, or a combination thereof for the plurality of blocks of MAC units.

Particular implementations of the subject matter described in this disclosure can be implemented to realize one or more of the following potential advantages. Aspects of the present disclosure may improve the flexibility of the AI network hardware to implement changes or updates in the trained AI model with low complexity and hardware cost. The approach for the AI network hardware permits reconfiguration programming that can be implemented on taped out ASIC, thereby obviating the need to redesign hardware due to updates or improvements in the AI model.

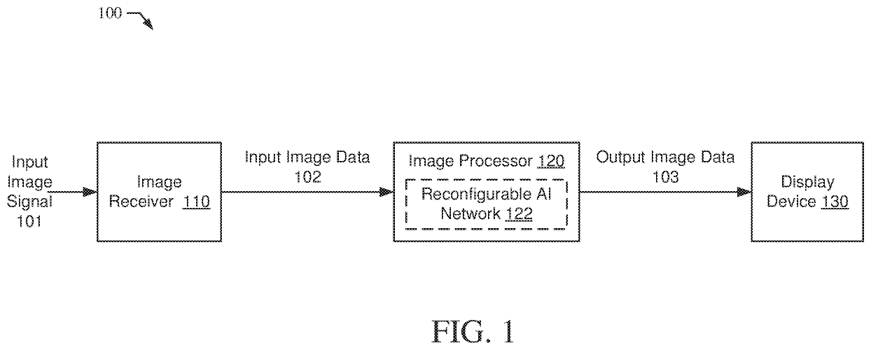

FIG. 1 shows a block diagram of an example image receiver and display system 100, according to some implementations. The system 100 includes an image receiver 110, an image processor 120, and a display device 130. The image receiver 110, for example, may receive input image signal 101 that contains one or more images to be displayed on the display device 130. For example, the image receiver 110 may be a set-top box that receives a TV-tuner input to be displayed on a television set or any other type of receiver that receives an input signal that is turned into a digital image (including video), e.g., input image data 102. In other example, the image receiver 110 may be a camera that receives light as the input image signal 101 and converts the light to a digital image, e.g., input image data 102. The image data 102 may include an array of pixels (or pixel values) representing a digital image. In some aspects, the image receiver 110 may output a sequence of image data 102 representing a sequence of frames of video content. The display device 130 (such as a television, computer monitor, smartphone, or any other device that includes an electronic display) renders or displays the digital image by reproducing the light pattern on an associated display surface. Although depicted as an independent block in FIG. 1, in actual implementations the image processor 120 may be incorporated or otherwise included in the image receiver 110, the display device 130, or a combination thereof.

The image processor 120 processes the digital image, i.e., the image data 102, which is converted to the output image data 103. The image processor 120 may scale the image, e.g., upscale or downscale the image, or may otherwise alter or adjust pixel values in the digital image. For example, the image processor 120 may be configured to change a resolution of the image data 102, e.g., based on the capabilities of the display device 130. The output image data 103, for example, may be a super-resolution (SR) image or an upconverted image that is scaled to match a resolution of the display device 130. The image processor 120, for example, may receive the input image data 102 and generate a new image for the output image data with a higher or lower number of pixels. In other implementations, the image processor 120 may be configured to correct various pixel distortions in the image data 102 to improve the quality of the digital image produced as the output image data 103.

As illustrated, at least a portion of the image processor 120 includes a reconfigurable AI network 122, which is implemented in hardware such as an ASIC. The reconfigurable AI network 122, for example, may include a plurality of layers, each of which includes a plurality of multiplier-accumulator (MAC) units. The MAC units in one or more layers are partitioned into blocks that may be combined in various configurations to enable different input depth sizes, output feature map sizes, or a combination thereof in the layer, and in some implementations to enable one or more “virtual” layers in addition to the multiple layers implemented in hardware. The reconfigurability of the AI network 122, e.g., through reconfiguration of the blocks of MAC units, enables updates or changes to the AI model for image processing implemented by the reconfigurable AI network 122.

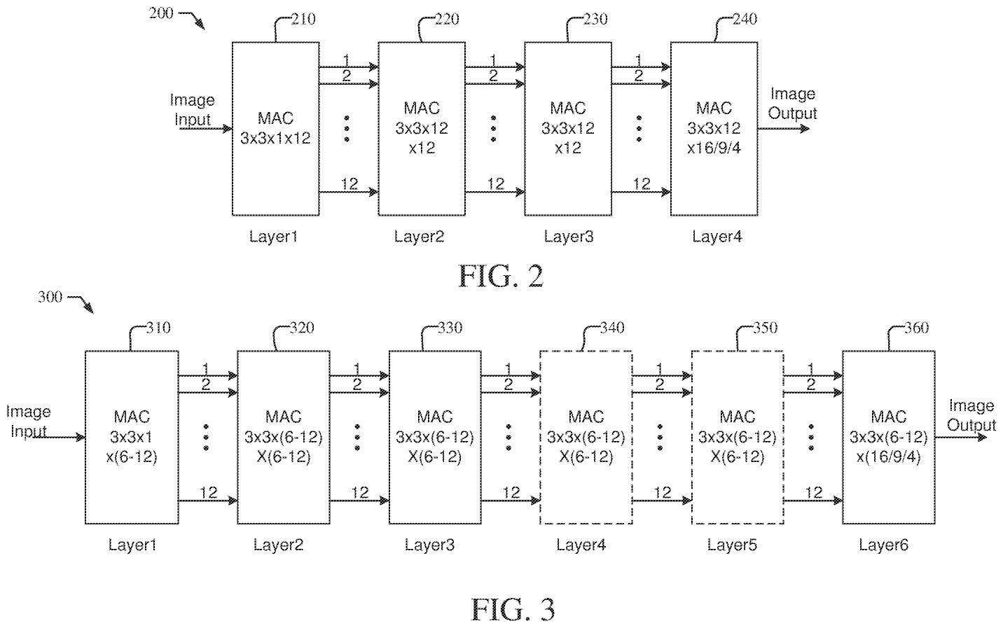

FIG. 2 shows a block diagram of an example four (4) layer AI network 200 configured for image processing. The AI network 200, for example, may be based on an initial AI model, e.g., for image scaling, and is static, i.e., AI network 200 is not reconfigurable.

The AI network 200 is a multi-layer design including four layers, layer1 210, layer2 220, layer3 230, and layer4 240. Each layer in AI network 200 includes a plurality of MAC units. The MAC units, for example, operate as two dimensional (2D) filters. The MAC size in each layer is identified as “fw×fh×D×F,” where “fw (filter width)×fh (filter height)” identifies the 2D filter size, “D” identifies the input depth size, and “F” identifies the output feature size. The filter size, for example, may be 3×3 pixels, 5×5 pixels, 7×7 pixels, etc. Moreover, the filter weights and interconnections between the various layers, input taps, feature maps, etc., is configured in the AI network 200 based on a desired AI model for image processing.

As illustrated, layer1 210 receives an image input, which is processed using 3×3×1×12 MAC units. Each 3×3 tap filter generates one output feature map per pixel. Layer1 210 has an input depth size of one and an output feature size of twelve and uses twelve of the 3×3 MAC units (i.e., 3×3×1×12 MAC units), to produce twelve feature maps per pixel, on output taps (1, 2, . . . 12) from layer1 210.

Layer2 220, with a depth size of twelve, receives the twelve feature maps per pixel from layer1 210 using 3×3×12 MACs to generate one feature map per pixel. Layer2 220 has an output feature size of twelve and uses twelve of the 3×3×12 MAC units (i.e., 3×3×12×12 MAC units), to produce twelve feature maps per pixel, on output taps (1, 2, . . . 12) from layer2 220.

Layer3 230 is similar to layer2 220 and, with a depth size of twelve, receives the twelve feature maps per pixel from layer2 220 using 3×3×12 MACs to generate one feature map per pixel. Layer3 230 has an output feature size of twelve and uses twelve of the 3×3×12 MAC units (i.e., 3×3×12×12 MAC units), to produce twelve feature maps per pixel, on output taps (1, 2, . . . 12) from layer3 230.

Layer4 240 is an output layer. Layer4 240, with a depth size of twelve, receives the twelve feature maps per pixel from layer3 230 using 3×3×12 MACs to generate one feature map per pixel. Depending on the image scaling ratio, e.g., 4, 3, or 2, the layer4 240 will produce either 16, 9, or 4 pixels for each input image pixel, respectively. Accordingly, layer4 240 may have an output feature size of 16, 9, or 4 and uses 16, 9, or 4 of the 3×3×12 MAC units (i.e., 3×3×12×16/9/4 MAC units), to generate the image output with the desired image scaling.

As discussed above, because the AI network 200 is implemented using hardware MAC units, the flexibility to reconfigure the AI network 200 to implement updates or changes in an AI model is not present. It is desirable to enable reconfiguration in AI network hardware that is sufficient to accommodate the AI model changes without burdening implementation with control paths and configurability related logics. For example, in some aspects, the reconfigurability of the AI network hardware may be implemented by portioning hardware units, e.g., MAC units, in one or more layers, into a plurality of blocks, wherein the blocks can be configured in various combinations to execute changes or updates of the AI model. In some implementations, the reconfigurability of the AI network hardware may be implemented using one or more virtual layers that optionally can be added to the hardware layers in the multi-layer design. In some implementations, the reconfigurability of the AI network hardware may be implemented by supporting different input depth sizes, different output feature map sizes, or a combination thereof in one or more layers, which may include virtual layers. Moreover, in some implementations, the reconfigurability of the AI network hardware may be implemented using sets of memories associated with layer, wherein any combination of blocks of hardware is receivable by any set of memories and a tap output from any set of memories is receivable by any combination of blocks of hardware.

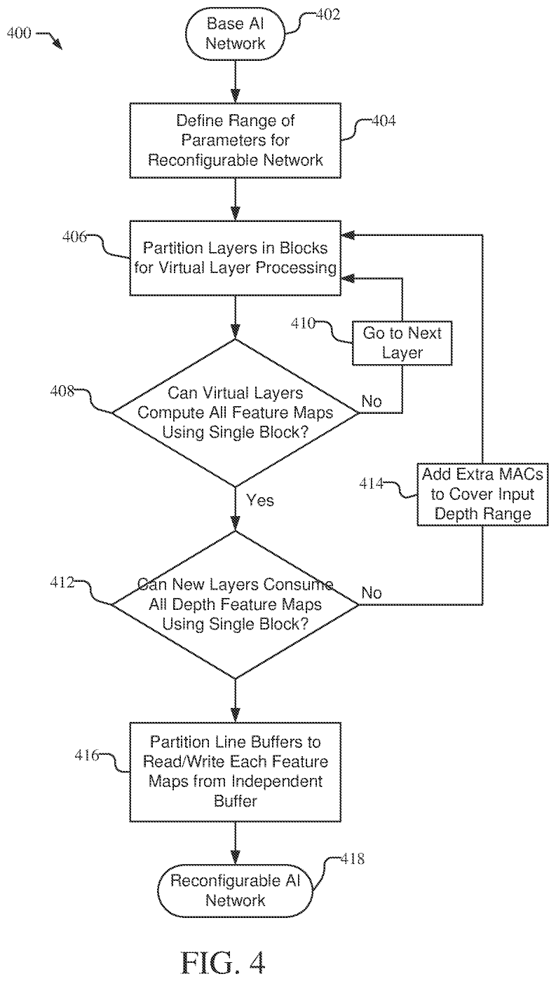

FIG. 3 shows a block diagram of an example of a reconfigurable AI network 300 configured for image processing. The design of AI network 300, for example, may be based on AI network 200, but modified to support reconfigurability. Thus, the AI network 300 may be based on an initial AI model, e.g., for image scaling, but AI network 300 may be reconfigured to implement updates or changes in the AI model.

The AI network 300, for example, may be similar to AI network 200, and is a multi-layer design, with each layer includes a plurality of hardware units (e.g., MAC units), identified as “fw×fh×D×F.” The filter size for the MAC units, for example, may be 3×3 pixels, 5×5 pixels, 7×7 pixels, etc. Moreover, the filter weights and interconnections between the various layers, input taps, feature maps, etc., may be configured in the AI network 300 based on an initial desired AI model for image processing. Unlike AI network 200, however, AI network 300 is reconfigurable, and may be reconfigured, e.g., to alter the number of layers (including adding layers via virtual layers), input taps, feature maps, etc., to implement updates or changes in the AI model.

AI network 300 includes four hardware layers, illustrated as layer1 310, layer2 320, layer3 330, and layer6 260, and optionally including two virtual layers (shown with dotted lines) illustrated as layer4 340 and layer5 350, located between hardware layer3 330 and layer6 630. Moreover, as illustrated by the identification of the MAC units in the hardware and virtual layers, one of or both of the input depth size D and the output feature size F may be variable.

Thus, as illustrated, layer1 310 is the input layer and receives an image input, which is processed a plurality of MAC 3×3 MAC units. Each 3×3 tap filter generates one output feature map per pixel. Layer1 310 has an input depth size of one and an output feature size which may be configured as 6, 8, 10 and 12 (illustrated as 6-12 in FIG. 3), and thus uses 6, 8, 10, or 12 of the 3×3 MAC units (i.e., 3×3×1×(6-12) MAC units), to produce 6, 8, 10, and 12 feature maps per pixel, on output taps (1, 2, . . . 12) from layer1 310.

Layer2 320 has a variable depth size of 6, 8, 10, or 12, and receives the 6, 8, 10, or 12 feature maps per pixel from layer1 310 using 3×3×(6-12) MACs to generate one feature map per pixel. Layer2 320 has an output feature size of 6, 8, 10, or 12, and uses 6, 8, 10, or 12 of the 3×3×(6-12) MAC units (i.e., 3×3×(6-12)×(6-12) MAC units), to produce 6, 8, 10, and 12 feature maps per pixel, on output taps (1, 2, . . . 12) from layer2 320.

Layer3 330 is similar to layer2 320 and, with a variable depth size of 6, 8, 10, or 12, receives the 6, 8, 10, or 12 feature maps per pixel from layer2 320 using 3×3×(6-12) MACs to generate one feature map per pixel. Layer3 330 has an output feature size of 6, 8, 10, or 12, and uses 6, 8, 10, or 12 of the 3×3×(6-12) MAC units (i.e., 3×3×(6-12)×(6-12) MAC units), to produce 6, 8, 10, or 12 feature maps per pixel, on output taps (1, 2, . . . 12) from layer3 330.

Layer4 340 is a virtual layer, which may be generated using one or more blocks of MACs from layer2 320 or layer3 330 or a combination thereof. Virtual layer4 340 may have a variable depth size of 6, 8, 10, or 12 and receives the 6, 8, 10, or 12 feature maps per pixel from layer3 330 using 3×3×(6-12) MACs to generate one feature map per pixel. Layer4 340 has an output feature size of 6, 8, 10, or 12, and uses 6, 8, 10, or 12 of the 3×3×(6-12) MAC units (i.e., 3×3×(6-12)×(6-12) MAC units), to produce 6, 8, 10, or 12 feature maps per pixel, on output taps (1, 2, . . . 12) from layer4 340.

Layer5 350 is another virtual layer, similar to virtual layer4 340, which may be generated using one or more blocks of MACs from layer2 320 or layer3 330 or a combination thereof. Virtual layer5 350 may have a variable depth size of 6, 8, 10, or 12 and receives the 6, 8, 10, or 12 feature maps per pixel from layer4 340 using 3×3×(6-12) MACs to generate one feature map per pixel. Layer5 350 has an output feature size of 6, 8, 10, or 12, and uses 6, 8, 10, or 12 of the 3×3×(6-12) MAC units (i.e., 3×3×(6-12)×(6-12) MAC units), to produce 6, 8, 10, or 12 feature maps per pixel, on output taps (1, 2, . . . 12) from layer5 350.

Layer6 360 is an output layer. Layer6 360, with a variable depth size of 6, 8, 10, or 12 and receives the 6, 8, 10, or 12 feature maps per pixel from layer5 350 using 3×3×(6-12) MACs to generate one feature map per pixel. Depending on the image scaling ratio, e.g., 4, 3, or 2, the layer6 360 will produce either 16, 9, or 4 pixels for each input image pixel, respectively. Accordingly, layer6 360 may have an output feature size of 16, 9, or 4 and uses 16, 9, or 4 of the 3×3×(6-12) MAC units (i.e., 3×3×(6-12)×16/9/4 MAC units), to generate the image output with the desired image scaling.

Accordingly, in the design of AI network 300, layer1 310 receives an input image. Layer2 320 to layer6 360 may be configured to receive an input depth size of 6, 8, 10, or 12. Layer1 310 to layer5 350 may be configured to generate a feature map size of 6, 8, 10, or 12. Layer6 360 generates the output image. While layer2 320 to layer3 360 are illustrated as receiving input from the immediately preceding layer, AI network 300 may be configured so that the input of any of these layers may be received from the output of any other layer.

In some implementation, the AI network 300 design may be implemented with no extra storage (with respect to AI network 200 design) to support tap formation for new virtual layers, which may result in an inability of all layers receiving input of twelve feature maps at the same time. Moreover, the design of AI network 300 may using existing MACs (with respect to design of AI network 200) to implement virtual layer4 340 and layer5 350.

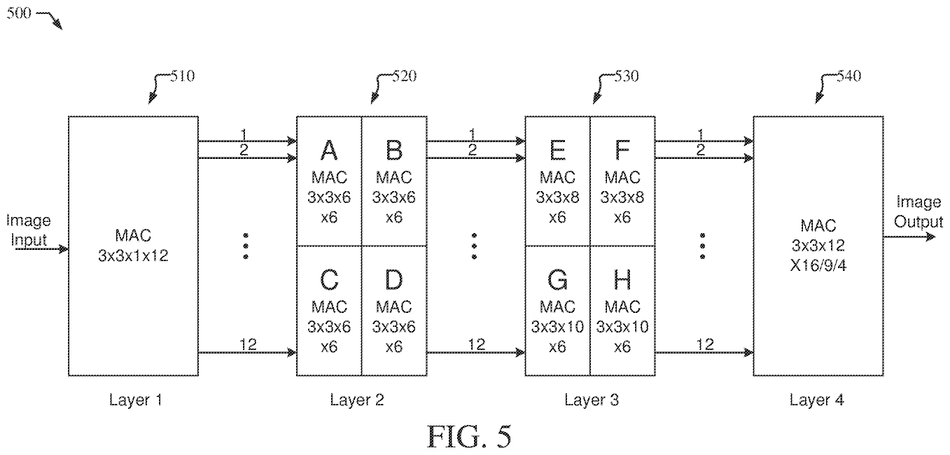

FIG. 4 shows an illustrative flowchart depicting an example process 400 to implement a reconfigurable multilayer image processing AI network, such as AI network 300 shown in FIG. 3.

As illustrated, the process 400 may begin with a base AI network design (402). The base AI network design, for example, may include a number of properties relevant to the implementing a desired AI model, such as the number of layers in the AI network, number of feature maps for each layer, the filter size for processing within each layer, quantization related to registers for each layer, and any other desired properties.

The range of parameters for the reconfigurable network is defined (404). For example, parameter ranges that may be defined may include one or more of the maximum number of layers, a minimum and maximum of the input depth size consumed by each layer, a minimum and maximum of the feature maps outputs produced by each layer, or a combination thereof.

The layers are partitioned into blocks of hardware units, e.g., MAC units, for processing in virtual layers (406). For example, based on the range of feature maps consumed by each layer (i.e., input depth size) and the range of feature map outputs from each layer, the existing MAC units are divided into blocks. The partitioning hardware units into blocks, for example, may be based on criteria such as: a) for each processing layer all computed feature maps should come out from a single processing block; b) for each processing layer all input depth feature maps should go to the same processing blocks; and c) line buffer storage will be partitioned to store each feature map in separate storage. These line buffers are required to generate filter taps for convolutions.

For example, as illustrated, a check is performed to determine if the virtual layers can compute all feature maps using a single block (408). If no, the layer cannot be partitioned, and the process proceeds to a next layer (410) and the process returns to block 408. If yes, a check is performed to determine if the new layers, e.g., the virtual layers and the modified hardware layers, can consume the input depth range of feature maps using a single block (412). If no, extra hardware units, e.g., MAC units, are added to cover the input depth range (414) and the process returns to block 408. Thus, to satisfy criteria a and b from above, if required extra MAC units are added to cover extra input depths or extra feature map outputs. If the decision at block 412) is yes, line buffers are partitioned to read and/or write each feature map from an independent buffer (416) to produce the reconfigurable AI network (418).

Using the above approach, it may be desirable to minimize the control flow logic. Further processing boundaries may be maintained, i.e., so that processing boundary for each layer does not cross each other and buffer allocation to all layers can occur seamlessly.

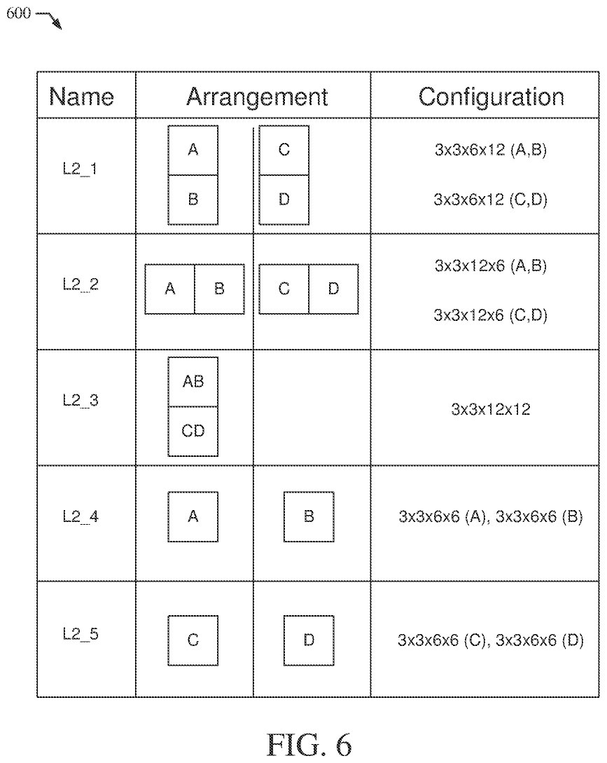

FIG. 5 shows a block diagram of an example of a reconfigurable AI network 500 configured for image processing. FIG. 5, for example, is similar to AI network 200 shown in FIG. 2 but illustrates a top-level partition of processing blocks to support the reconfigurable network, which may be generated, e.g., using the procedure illustrated in FIG. 4.

Similar to AI network 200 shown in FIG. 2, the AI network 500 is a multi-layer design, with each layer includes a plurality of hardware units (e.g., MAC units), identified as “fw×fh×D×F.” The filter size for the MAC units, for example, may be 3×3 pixels, 5×5 pixels, 7×7 pixels, etc. Moreover, the filter weights and interconnections between the various layers, input taps, feature maps, etc., may be configured in the AI network 500 based on a desired AI model for image processing. For example, unlike AI networks 200, one or more layers in AI network 500 are portioned into a plurality of blocks of MAC units, e.g., to implement virtual layers, such as illustrated in the reconfigurable AI network 300. For example, as illustrated in FIG. 5, while the input and output layers in AI network 500 are unmodified, and thus are the same as the input output layers in AI network 200, layer2 520 and layer3 530 are portioned into plurality of blocks of MAC units, identified as blocks A, B, C, and D in layer2 520 and blocks E, F, G, and H in layer3 530.

Thus, as illustrated, the input layer1 510 may be the same as input layer1 210 shown in FIG. 2. Input layer1 510 receives an image input, which is processed a plurality of MAC 3×3 MAC units. Each 3×3 tap filter generates one output feature map per pixel. Layer1 510 has an input depth size of one and an output feature size of twelve and uses twelve of the 3×3 MAC units (i.e., 3×3×1×12 MAC units), to produce twelve feature maps per pixel, on output taps (1, 2, . . . 12) from layer1 510. If desired, however, at least a portion of the input layer1 510 may be partitioned into blocks of MAC units, for example, if extra MAC units are added to layer1 510.

Layer2 520 has a total depth size of twelve, receiving the twelve feature maps from layer1 510 and produces up to twelve feature maps per pixel, on output taps (1, 2, . . . 12). Layer2 520 has a total number of MAC units that is the same as included in layer2 210, shown in FIG. 2, but the total number of MAC units are partitioned to support a plurality of blocks, illustrated as blocks A, B, C, and D, each of which support independent or combined processing. As illustrated, each block A, B, C, and D comprises 3×3×6×6 MACs and may be used in pairs or independently in various configurations.

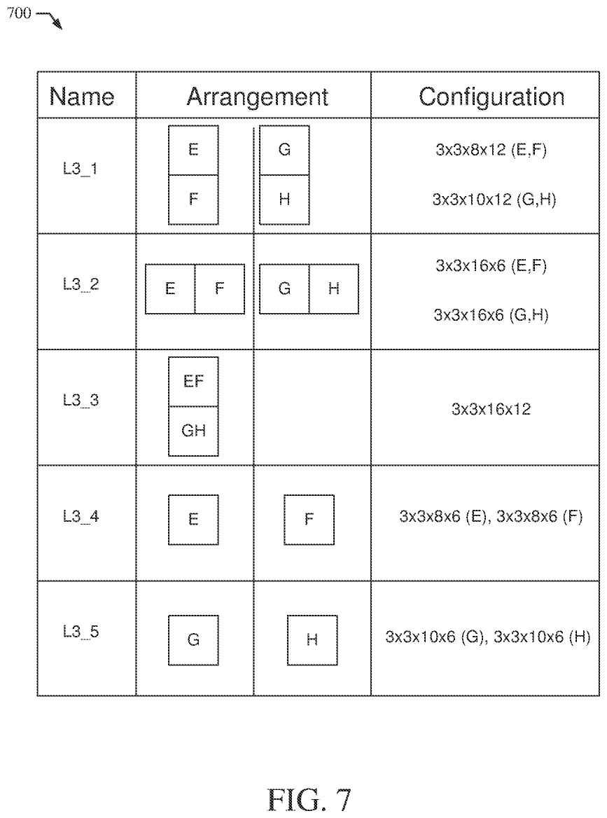

FIG. 6, by way of example, shows a table 600 that illustrates various arrangements and the resulting configurations that may be supported by blocks A, B, C, D in layer2 520. For example, as illustrated in row L2_1, the blocks may be arranged by combining blocks A and B and blocks C and D to produce a configuration of 3×3×6×12 MACs for blocks A and B, and a configuration of 3×3×6×12 MACs for blocks C and D. As illustrated in row L2_2, the blocks may be arranged by another combination of blocks A and B and blocks C and D to produce a configuration of 3×3×12×6 MACs for blocks A and B, and a configuration of 3×3×12×6 MACs for blocks C and D. As illustrated in row L2_3, the blocks A, B, C, and D may be arranged together to produce the configuration of 3×3×12×12 MACs, as used in layer2 220 of AI network 200 shown in FIG. 2. As illustrated in row L2_4, the blocks A and B may be used individually to produce a configuration of 3×3×6×6 MACs for each of blocks A and B. Additionally, as illustrated in row L2_5, the blocks C and D may be used individually to produce a configuration of 3×3×6×6 MACs for each of blocks C and D.

As illustrated in FIG. 5, layer3 530 has a total depth size of twelve, receiving up to twelve feature maps from layer2 520 and produce up to twelve feature maps per pixel, on output taps (1, 2, . . . 12). Layer3 530 has the MAC units partitioned to support a plurality of blocks, illustrated as blocks E, F, G, and H, each of which support independent or combined processing. The total number of MAC units included in layer3 530 is increased to support additional input depth size. For example, the blocks E and F are enhanced, e.g., MAC units are added, to support a depth size of 8, instead of a depth size 6 as used in layer2 520. The blocks G and H are enhanced, e.g., MAC units are added, to support a depth size of 10, instead of a depth size 6 as used in layer2 520. Similar to layer2 520, the blocks E, F, G, and H in layer3 530 may be used pairs or independently in various configurations.

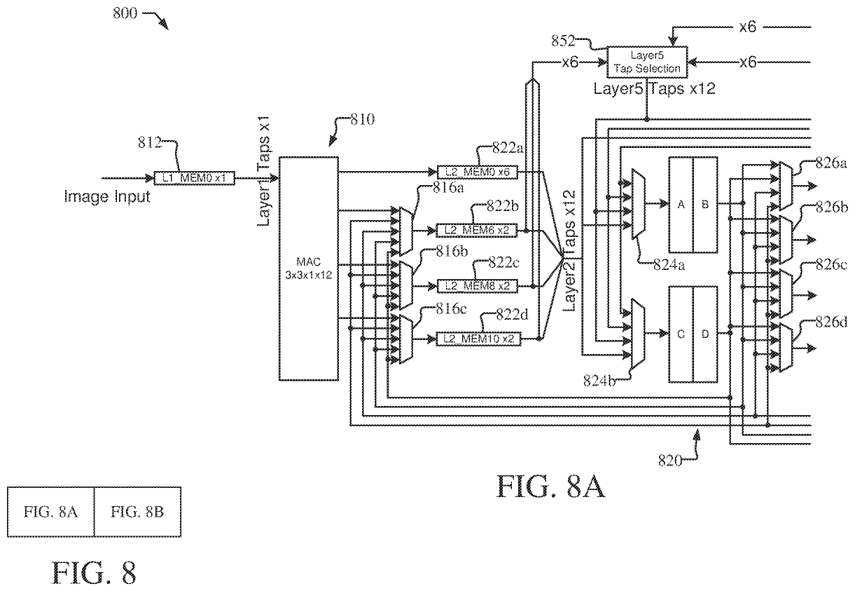

FIG. 7, by way of example, shows a table 700 that illustrates various arrangements and the resulting configurations that may be supported by blocks E, F, G, H in layer3 530. For example, as illustrated in row L3_1, the blocks may be arranged by combining blocks E and F and blocks G and H to produce a configuration of 3×3×8×12 MACs for blocks E and F, and a configuration of 3×3×10×12 MACs for blocks G and H. As illustrated in row L3_2, the blocks may be arranged by another combination of blocks E and F and blocks G and H to produce a configuration of 3×3×16×6 MACs for blocks E and F, and a configuration of 3×3×16×6 MACs for blocks G and H. As illustrated in row L3_3, the blocks E, F, G, and H may be arranged together to produce the configuration of 3×3×16×12 MACs. As illustrated in row L3_4, the blocks E and F may be used individually to produce a configuration of 3×3×8×6 MACs for each of blocks E and F. Additionally, as illustrated in row L3_5, the blocks G and H may be used individually to produce a configuration of 3×3×10×6 MACs for each of blocks G and H.

The output layer4 540 may be the same as output layer4 240 shown in FIG. 2. Layer4 540, with a depth size of twelve, receives the twelve feature maps per pixel from layer3 530 using 3×3×12 MACs to generate one feature map per pixel. Depending on the image scaling ratio, e.g., 4, 3, or 2, the layer4 540 will produce either 16, 9, or 4 pixels for each input image pixel, respectively. Accordingly, layer4 540 may have an output feature size of 16, 9, or 4 and uses 16, 9, or 4 of the 3×3×12 MAC units (i.e., 3×3×12×16/9/4 MAC units), to generate the image output with the desired image scaling. If desired, however, at least a portion of the input layer4 540 may be partitioned into blocks of MAC units, for example, if extra MAC units are added to layer1 540.

By partitioning at least one of the layers in the AI network into a plurality of blocks of MAC units, e.g., layer2 520 and layer3 530 of AI network 500, the blocks may be configured into various arrangements to achieve a desired processing configuration to support various AI models. Accordingly, the AI network may be configured to support various AI models by adjusting the arrangements of the blocks of MAC units to achieve at least one of the following: add one or more virtual layers, adjust the input depth size consumed by each layer, adjust feature maps outputs produced by each layer, or any combination thereof.

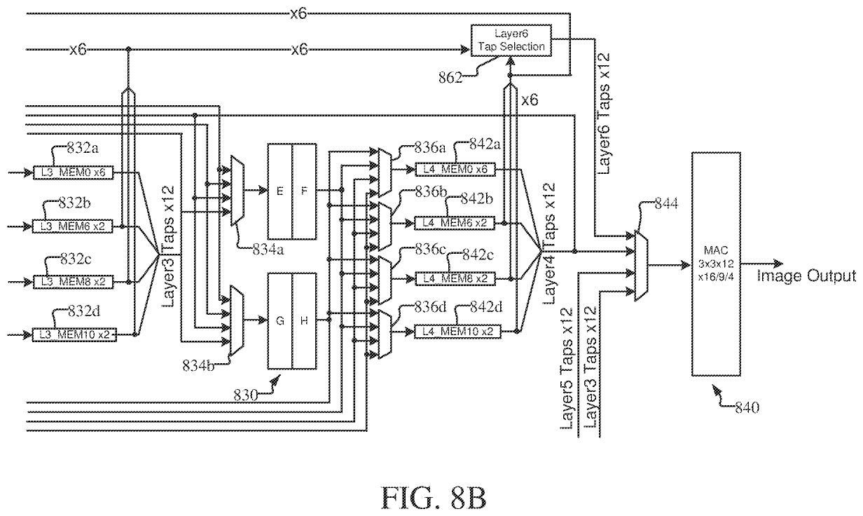

FIG. 8, which is partitioned into FIGS. 8A and 8B, illustrates an example of a control path for an AI network 800 to support a plurality of configurations, such as illustrated in FIGS. 5, 6, and 7. The AI network 800, as illustrated, includes a physical input layer and a physical output layer and is configurable to include one or more (up to four) intermediate layers based on the control path and partitioning of processing blocks. For example, when AI network 800 is configured as a 3 layer AI network, layer1 is a physical input layer, layer2 is a physical intermediate layer, layer3 is a physical output layer. When AI network 800 is configured as a 4 layer AI network, layer1 is a physical input layer, layer2 and layer3 are physical intermediate layers, and layer4 is a physical output layer. When AI network 800 is configured as a 5 layer AI network, layer1 is a physical input layer, layer2 and layer3 are physical intermediate layers, layer4 is an intermediate virtual layer, and layer5 is a physical output layer. When AI network 800 is configured as a 6 layer AI network, layer1 is physical input layer, layer2 and Layer3 are physical intermediate layers, layer4 and layer5 are intermediate virtual layers, and layer6 is a physical output layer.

As illustrated in the control path for AI network 800, memories (MEM) are used for tap generation. For example, one dual-line SRAM may be used for each feature map. Each MEM unit stores two lines.

As illustrated, AI network 800 includes a physical input layer (layer1) that receives the image input and includes a control path with memory 812 (L1_MEM0) for generation of layer1 taps x1. The memory 812 is dedicated to layer1 processing block 810. The physical input layer receives the input image via memory 812, which is processed using 3×3×1×12 MAC units in processing block 810. The physical input layer (layer1) has an output feature size of twelve. For example, feature maps 1-6 may be provided directly to a physical intermediate layer (layer2), and feature maps 7-12 may be provided to multiplexers 816a, 816b, 816c (sometimes collectively referred to as multiplexers 816), which also receive feature maps from processing block 820 and processing block 830.

A physical intermediate layer of the AI network 800, generally designated as layer2, includes a control path with memory L2_MEM<0 . . . 12>, one for each input depth, for generation of layer2 taps x12, multiplexers 824a, 824b (collectively referred to as multiplexers 824), processing block 820, and multiplexers 826a, 826b, 826c, and 826d (sometimes collectively referred to as multiplexers 826). For example, the memory L2_MEM<0 . . . 12> is illustrated as memory 822a (L2_Mem0 x6), memory 822b (L2_Mem6 x2), memory 822c (L2_Mem8 x2), and memory 822c (L2_Mem10 x2) (sometimes collectively referred to as memory 822). Memory 822a receives feature maps 1-6 from layer1, and memories 822b, 822c, and 822d may receive feature maps 7-8, 9-10, and 11-12 via multiplexers 816b, 816c, and 816d, respectively. The memory 822 is grouped into sets of 6+2+2+2 to support 6, 8, 10, and 12 feature map depth size. The memory L2_MEM0-L2_MEM11, illustrated as memory 822, is provided to layer2 taps x12 and may be provided to processing block 820 in layer2 via multiplexers 824 and may be provided to processing block 830 in layer3 via multiplexers 834a, 834b (collectively referred to as multiplexers 834). Additionally, the memory L2_MEM6-L2_MEM11, illustrated as memory 822b, 822c, and 822d, may be provided to layer5 via the layer5 tap selection 852. Multiplexers 824 receive input from layer2 taps x12 and additionally receive input from layer3 taps, layer4 taps, or layer5 taps. Processing block 820 includes pairs or individual blocks of MAC units, illustrated as blocks A, B, C, and D, which may be the same as blocks A, B, C, and D in AI network 500 shown in FIG. 5, and receives the output from multiplexers 824, and thus, may receive feature maps from one or more of the layer2 taps, layer3 taps, layer4 taps, or layer5 taps. Based on the arrangement of blocks A, B, C, D in the processing block 820 as discussed above, the output feature size may be 6, 8, 10 or 12, which is provided to multiplexers 826. Multiplexers 826 further receive feature maps from processing block 830.

A physical intermediate layer of the AI network 800, generally designated as layer3, is similar to layer2, and includes a control path with memory L3_MEM<0 . . . 12>, one for each input depth, for generation of layer3 taps x12, multiplexers 834, and processing block 830, and multiplexers 836a, 836b, 836c, and 836d (collectively referred to as multiplexers 836). For example, the memory L3_MEM<0 . . . 12> is illustrated as memory 832a (L3_Mem0 x6), memory 832b (L3_Mem6 x2), memory 832c (L3_Mem8 x2), and memory 832c (L3_Mem10 x2) (sometimes collectively referred to as memory 832). Memories 832a, 832b, 832c, and 832d may receive feature maps via multiplexers 826a, 826b, 826c, and 826d, respectively. The memory 832 is grouped into sets of 6+2+2+2 to support 6, 8, 10, and 12 feature map depth size. The memory L3_MEM1-L3_MEM11, illustrated as memory 832, is provided to layer3 taps x12 and may be provided to processing block 830 in layer3 via multiplexers 834 and may be provided to processing block 820 in layer2 via multiplexers 824 and may be provided to processing block 840 via multiplexer 844. Additionally, the memory L3_MEM6-L3_MEM11, illustrated as memory 832b, 832c, and 832d, may be provided to layer5 and layer6 via the layer5 tap selection 852 and the layer6 tap selection 862. Multiplexers 834 receive input from layer3 taps x12 and additionally receive input from layer2 taps, layer4 taps, or layer5 taps. Processing block 830 includes pairs or individual blocks of MAC units, illustrated as blocks E, F, G, and H which may be the same as blocks E, F, G, and H in AI network 500 shown in FIG. 5, and receives the output from multiplexers 834, and thus, may receive feature maps from one or more of the layer2 taps, layer3 taps, layer4 taps, or layer5 taps. Based on the arrangement of blocks E, F, G, and H in the processing block 830 as discussed above, the output feature size may be 6, 8, 10 or 12, which is provided to multiplexers 836. Multiplexers 836 further receive feature maps from processing block 820.

Layer4 control path includes memory L4_MEM<0 . . . 12>, one for each input depth, for generation of layer4 taps x12, multiplexer 844, and processing block 840. For example, the memory is illustrated as memory 842a (L4_Mem0 x6), memory 842b (L4_Mem6 x2), memory 842c (L4_Mem8 x2), and memory 842c (L4_Mem10 x2) (sometimes collectively referred to as memory 842). Memories 842a, 842b, 842c, and 842d may receive feature maps via multiplexers 836a, 836b, 836c, and 836d, respectively. The memory 842 is grouped into sets of 6+2+2+2 to support 6, 8, 10, and 12 feature map depth size. The memory L4_MEM1-L4_MEM11, illustrated as memory 842 is provide to layer4 taps x12 and may be provided to processing block 840 via multiplexer 844 and may be provided to processing block 820 in layer2 via multiplexers 824 and may be provided to processing block 830 in layer3 via multiplexers 834. Additionally, the memory L4_MEM6-L4_MEM11, illustrated as memory 842b, 842c, and 842d, may be provided to layer5 and layer6 via the layer5 tap selection 852 and the layer6 tap selection 862. Multiplexer 844 receives input from layer4 taps x12 and additionally receives input from layer3 taps, layer5 taps and layer6 taps. The multiplexer 844 controls the tap input to the output processing block 840, e.g., depending on the number of layers configured in the AI network 800. For example, for a 3 layer AI network, the multiplexer 844 may select the layer3 taps as the input to the processing block 840. For a 4 layer AI network, the multiplexer 844 may select the layer4 taps as the input to the processing block 840. For a 5 layer AI network, the multiplexer 844 may select the layer5 taps as the input to the processing block 840. For a 6 layer AI network, the multiplexer 844 may select the layer6 taps as the input to the processing block 840.

The processing block 840 serves as the physical output layer and includes 3×3×12 MAC units that receive the output from multiplexer 844. Depending on the image scaling ratio, e.g., 4, 3, or 2, the processing block 840 will produce either 16, 9, or 4 pixels for each input image pixel, respectively. Accordingly, processing block 840 may have an output feature size of 16, 9, or 4 and uses 16, 9, or 4 of the 3×3×12 MAC units (i.e., 3×3×12×16/9/4 MAC units), to generate the image output with the desired image scaling.

Layer5 may be selected via layer5 tap selection 852. Layer5 tap selection 852 receives input taps from layer2 taps, layer3 taps, and layer4 taps and produces a layer5 Taps x12 output that is coupled to multiplexers 824, and multiplexers 834, and multiplexer 844.

Layer6 may be selected via layer6 tap selection 862. Layer6 tap selection 862 receives input taps from layer3 taps and layer4 taps, and produces a layer6 Taps x12 output that is coupled to multiplexer 844. Thus, as illustrated, any combination of memory 832b (L3_Mem6 x2), memory 832c (L3_Mem8 x2), and memory 832c (L3_Mem10 x2), and memory 842b (L4_Mem6 x2), memory 842c (L4_Mem8 x2), and memory 842c (L4_Mem10 x2) can be the tap input for layer6 tap selection 862 to be received by layer4 840 MAC (3×3×12×16/9/4 MAC units). As an example, the output from memory 832d (L3_Mem10 x2), memory 842b (L4_Mem6 x2), memory 842c (L4_Mem8 x2), and memory 842d (L4_Mem10 x2) can form eight taps from layer6 tap selection 862 to be received by layer4 840 MAC (3×3×12×16/9/4 MAC units).

Thus, the various pairs of blocks of MAC units, e.g., pairs, AB, CD, EF, GH, in processing block 820 and processing block 830 may be shared amongst layer2, layer3, layer4, and layer5 via multiplexers 824 and multiplexers 834. Feature maps produced by any pair of blocks of MAC units may be provided to any set of memories, via multiplexers 816, 826, and 836. Moreover, the tap output from any set of memories may be provided to any pair of blocks of MAC units, e.g., via multiplexers 824 and multiplexers 834.

By configuring the multiplexers 816, 824, 826, 834, 836, and 844, and layer5 tap selection 852 and layer6 tap selection 862, various configurations of layers, input feature depth per layer, and output feature map per layer are supported.

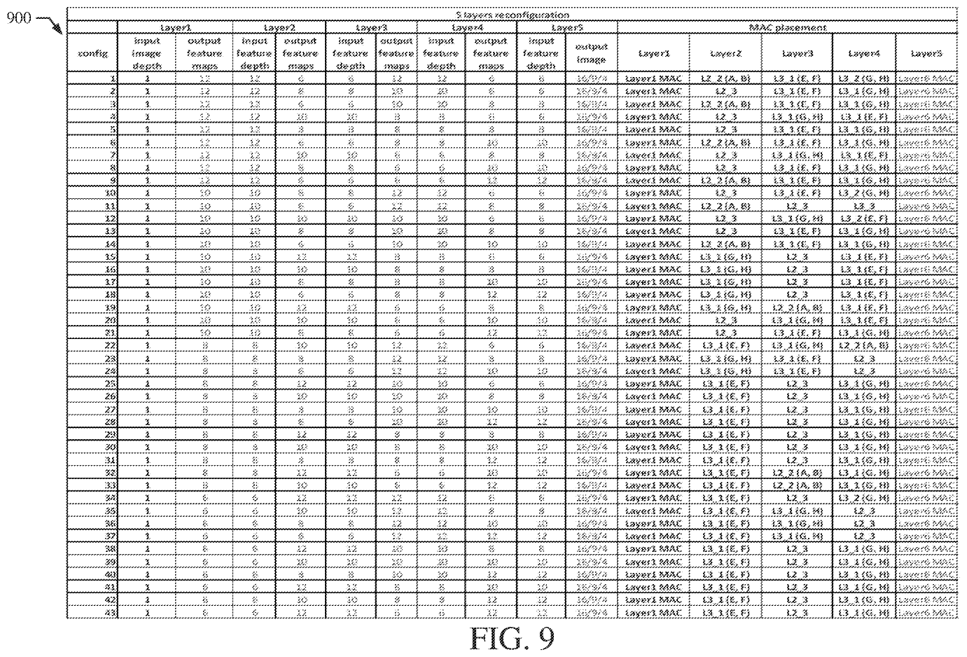

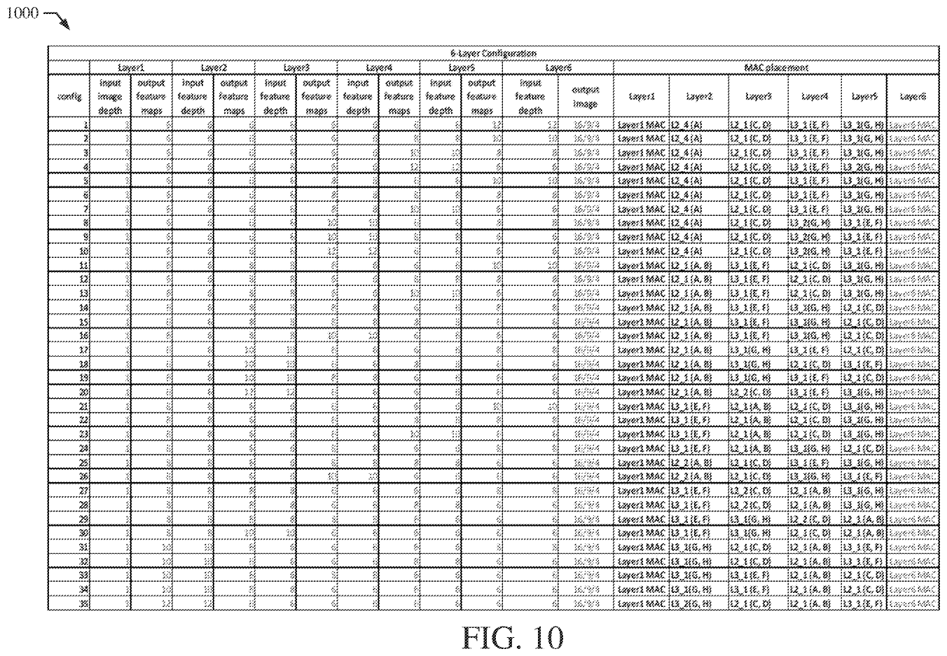

FIGS. 9 and 10, by way of example, show tables 900 and 1000, respectively, which illustrates various arrangements and the resulting configurations that may be supported AI network 800. Table 900 in FIG. 9, for example, illustrates a 5-layer configuration, e.g., using one virtual layer, and table 1000 in FIG. 10 illustrates a 6-layer configuration, e.g., using two virtual layers. For any subset configurations where all feature map/depth interfaces are not being used, these may be configured by programming the MAC coefficient values to zeros.

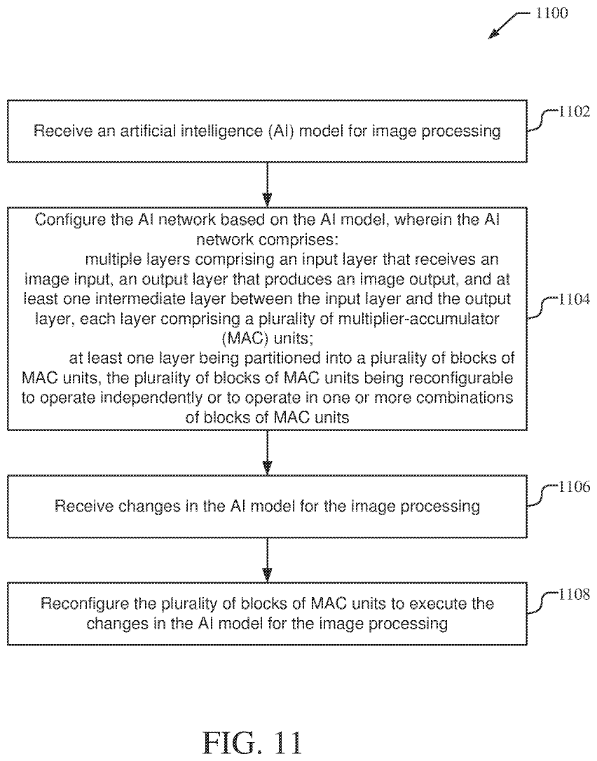

FIG. 11 shows an illustrative flowchart depicting an example operation 1100 of reconfiguring an artificial intelligence (AI) network on an application specific integrated circuit (ASIC) operable as a reconfigurable multilayer image processor, according to some implementations. In some implementations, the example operation 1100 may be performed, for example, to reconfigure an AI network, such as one of AI networks 300, 500, or 800 shown in FIG. 3, 5, or 8, respectively. As discussed above, the reconfigurable AI network may be designed according to a process that partitions a plurality of hardware units, e.g., MAC units, into a plurality of blocks that can be reconfigurably arranged to operate independently or to operate in one or more combinations, e.g., as discussed in reference to process 400 shown in FIG. 4.

As illustrated in FIG. 11, the AI network receives an artificial intelligence (AI) model for image processing (1102). The AI network is configured based on the AI model, wherein the AI network comprises includes multiple layers comprising an input layer that receives an image input, an output layer that produces an image output, and at least one intermediate layer between the input layer and the output layer, each layer comprising a plurality of multiplier-accumulator (MAC) units, and at least one layer being partitioned into a plurality of blocks of MAC units, the plurality of blocks of MAC units being reconfigurable to operate independently or to operate in one or more combinations of blocks of MAC units (1104). For example, the AI network may be similar to AI network 500 or AI network 800 shown in FIG. 5 or 8 and the blocks of MAC units may be arranged to implement a desired configuration, as illustrated in tables 600, 700, 900, or 1000 illustrated in FIG. 6, 7, 9, or 10. In some implementations, multiple layers are partitioned into the plurality of blocks of MAC units, e.g., as discussed in reference to FIGS. 5 and 8. In some implementations, each MAC unit may be a two-dimensional (2D) filter, e.g., as discussed in reference to FIGS. 2, 3 and 5. Changes in the AI model for the image processing are received (1106). The plurality of blocks of MAC units are reconfigured to execute the changes in the AI model for the image processing (1108). For example, the blocks of MAC units may be rearranged to implement a different desired configuration, as illustrated in tables 600, 700, 900, or 1000 illustrated in FIG. 6, 7, 9, or 10.

In some implementations, the image processing performed by the AI network may be image scaling.

In some implementations, the plurality of blocks of MAC units may be reconfigurable to operate independently or to operate in one or more combinations of blocks of MAC units to enable implementation of one or more virtual layers in addition to the multiple layers, e.g., as discussed in reference to FIGS. 3, 5, 8, 9, and 10.

In some implementations, reconfiguring the plurality of blocks of MAC units reconfigures an input depth size, output feature map size, or a combination thereof for the at least one layer partitioned into the plurality of blocks of MAC units, e.g., as discussed in reference to FIGS. 3, 5, 8, 9, and 10. In some aspects, for example, different blocks of MAC units in the plurality of blocks of MAC units support different input depth sizes, different output feature map sizes, or a combination thereof, e.g., as discussed in reference to FIGS. 5 and 8.

In some implementations, each of the at least one intermediate layer has an input depth size for receiving a plurality of feature maps from a preceding layer and an output feature map size for producing a plurality of feature map outputs. The plurality of blocks of MAC units may be reconfigured to execute the changes in the AI model for the image processing by arranging the plurality of blocks of MAC units to operate independently or to operate in one or more combinations of blocks of MAC units to enable at least one of implementation of one or more virtual layers between the input layer and the output layer, reconfiguration of the input depth size of the at least one intermediate layer, reconfiguration of the output feature map size of the at least one intermediate layer, or a combination thereof, e.g., as discussed in reference to FIGS. 3, 5, 8, 9, and 10. In some aspects, for example, the image output comprises a plurality of pixels for each respective pixel in the image input.

In some implementations, each layer comprises sets of memories associated with each layer for tap generation, wherein any combination of blocks of MAC units is receivable by any set of memories and a tap output from any set of memories is receivable by any combination of blocks of MAC units, e.g., as discussed in reference to FIGS. 8, 9, and 10.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. An artificial intelligence (AI) network on an application specific integrated circuit (ASIC) operable as a reconfigurable multilayer image processor comprising:
multiple layers comprising an input layer that receives an image input, an output layer that produces an image output, and at least one intermediate layer between the input layer and the output layer; each layer comprising a plurality of multiplier-accumulator (MAC) units; and
at least one layer is partitioned into a plurality of blocks of MAC units, the plurality of blocks of MAC units being reconfigurable to operate independently or to operate in one or more combinations of blocks of MAC units, wherein reconfiguration of the plurality of blocks of MAC units executes changes in an AI model for the image processing.

2. The AI network of claim 1, wherein the image processing comprises image scaling.

3. The AI network of claim 1, wherein the plurality of blocks of MAC units being reconfigurable to operate independently or to operate in one or more combinations of blocks of MAC units enables implementation of one or more virtual layers in addition to the multiple layers.

4. The AI network of claim 1, wherein the plurality of blocks of MAC units being reconfigurable to operate independently or to operate in one or more combinations of blocks of MAC units enables reconfiguration of an input depth size, output feature map size, or a combination thereof for the at least one layer partitioned into the plurality of blocks of MAC units.

5. The AI network of claim 4, wherein different blocks of MAC units in the plurality of blocks of MAC units support different input depth sizes, different output feature map sizes, or a combination thereof.

6. The AI network of claim 1, wherein multiple layers are partitioned into the plurality of blocks of MAC units.

7. The AI network of claim 1, wherein each MAC unit comprises a two-dimensional (2D) filter.

8. The AI network of claim 1, wherein:
each of the at least one intermediate layer has an input depth size for receiving a plurality of feature maps from a preceding layer and an output feature map size for producing a plurality of feature map outputs; and
the plurality of blocks of MAC units being reconfigurable to operate independently or to operate in one or more combinations of blocks of MAC units enables at least one of: implementation of one or more virtual layers between the input layer and the output layer, reconfiguration of the input depth size of the at least one intermediate layer, reconfiguration of the output feature map size of the at least one intermediate layer, or a combination thereof.

9. The AI network of claim 8, wherein the image output comprises a plurality of pixels for each respective pixel in the image input.

10. The AI network of claim 1, wherein each layer comprises sets of memories associated with each layer for tap generation, wherein any combination of blocks of MAC units is receivable by any set of memories and a tap output from any set of memories is receivable by any combination of blocks of MAC units.

11. A method of reconfiguring an artificial intelligence (AI) network on an application specific integrated circuit (ASIC) operable as a reconfigurable multilayer image processor, comprising:
receiving an artificial intelligence (AI) model for image processing;
configuring the AI network based on the AI model, wherein the AI network comprises:
multiple layers comprising an input layer that receives an image input, an output layer that produces an image output, and at least one intermediate layer between the input layer and the output layer, each layer comprising a plurality of multiplier-accumulator (MAC) units;
at least one layer being partitioned into a plurality of blocks of MAC units, the plurality of blocks of MAC units being reconfigurable to operate independently or to operate in one or more combinations of blocks of MAC units;
receiving changes in the AI model for the image processing; and
reconfiguring the plurality of blocks of MAC units to execute the changes in the AI model for the image processing.

12. The method of claim 11, wherein the image processing comprises image scaling.

13. The method of claim 11, wherein the plurality of blocks of MAC units being reconfigurable to operate independently or to operate in one or more combinations of blocks of MAC units enables implementation of one or more virtual layers in addition to the multiple layers.

14. The method of claim 11, wherein reconfiguring the plurality of blocks of MAC units reconfigures an input depth size, output feature map size, or a combination thereof for the at least one layer partitioned into the plurality of blocks of MAC units.

15. The method of claim 14, wherein different blocks of MAC units in the plurality of blocks of MAC units support different input depth sizes, different output feature map sizes, or a combination thereof.

16. The method of claim 11, wherein multiple layers are partitioned into the plurality of blocks of MAC units.

17. The method of claim 11, wherein each MAC unit comprises a two-dimensional (2D) filter.

18. The method of claim 11, wherein:
each of the at least one intermediate layer has an input depth size for receiving a plurality of feature maps from a preceding layer and an output feature map size for producing a plurality of feature map outputs;
reconfiguring the plurality of blocks of MAC units to execute the changes in the AI model for the image processing comprises arranging the plurality of blocks of MAC units to operate independently or to operate in one or more combinations of blocks of MAC units to enable at least one of implementation of one or more virtual layers between the input layer and the output layer, reconfiguration of the input depth size of the at least one intermediate layer, reconfiguration of the output feature map size of the at least one intermediate layer, or a combination thereof.

19. The method of claim 18, wherein the image output comprises a plurality of pixels for each respective pixel in the image input.

20. The method of claim 11, wherein each layer comprises sets of memories associated with each layer for tap generation, wherein any combination of blocks of MAC units is receivable by any set of memories and a tap output from any set of memories is receivable by any combination of blocks of MAC units.
